(19) United States
(12) Patent Application Publication
(10) Pub. No.: US 2026/0230312 A1
(43) Pub. Date: Aug. 6, 2026

(54) AI-Quantum Middleware and Operating System for Distributed, Modular, Post-Quantum Secure Hybrid Workload Execution and Autonomous Decision Optimization

(71) Applicants: Jay Allan Shears, Durango, CO (US); Anirban Mukherjee, Mumbai (IN)

(72) Inventors: Jay Allan Shears, Durango, CO (US); Anirban Mukherjee, Mumbai Maharashtra (IN)

(21) Appl. No.: 19/087,516

(22) Filed: Mar. 23, 2025

Related U.S. Application Data
(60) Provisional application No. 63/752,720, filed on Feb. 1, 2025.

(51) Int. Cl. H04L 9/08; H04L 9/32

(52) U.S. Cl. CPC H04L 9/0852; H04L 9/32

(57) ABSTRACT

A modular artificial intelligence (AI) and quantum computing middleware system enables real-time, post-quantum secure hybrid workload orchestration across classical and quantum-simulated environments. The system includes a tensor factorization engine that emulates 60-100+ qubit-scale inference using classical infrastructure, a universal API gateway for cross-platform model execution, and a cryptographic security layer implementing continuous-variable quantum key distribution (CV-QKD) and lattice-based encryption. Additional modules support swarm coordination using quantum tensor networks, explainable AI for compliance traceability, and a digital twin interface for real-time validation. The invention enables secure, scalable deployment in edge-native, cloud-based, and air-gapped environments for aerospace, defense, and intelligent infrastructure applications.

### CROSS-REFERENCE TO RELATED APPLICATIONS

This application claims the benefit of priority under 35 U.S.C. § 119(e) to U.S. Provisional Patent Application No. 63/752,720, filed on Feb. 1, 2025, the entire contents of which are hereby incorporated by reference.

### STATEMENT REGARDING FEDERALLY SPONSORED RESEARCH OR DEVELOPMENT

### The Names of the Parties to a Joint Research Agreement

Not applicable. No federally sponsored research or development was used in the conception or reduction to practice of the invention disclosed in this application.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable. No material has been submitted on a compact disc or as a text file via the Office Electronic Filing System (EFS-Web) for incorporation by reference in this application.

### STATEMENT REGARDING PRIOR DISCLOSURES BY THE INVENTOR OR A JOINT INVENTOR

The subject matter of this application was publicly disclosed by the inventor prior to the filing date of the U.S. Provisional Patent Application No. 63/752,720, filed Feb. 1, 2025. Specifically, technical disclosures substantially describing the invention were made by the inventor through the publication of a series of blog posts on the official BEYONDx Advisors website in early January 2025.

These blog articles were published at the following URLs:
https://www.beyondxadvisors.com/blog-3-1/4x0v9tb4ybgisx2f6vil5rgmeejxoj
https://www.beyondxadvisors.com/blog-3-1/crjjg0opc5saup3dj71145bpqoOpOt
https://www.beyondxadvisors.com/blog-3-1/1hfnzng6u2wzitthhbi9z7azoym31g
https://www.beyondxadvisors.com/blog-3-1/u88gqk580v169k993qc4evlwop8c4q

These disclosures are relied upon under 35 U.S.C. § 102(b)(1)(A) and are considered prior disclosures made by the inventor within the one-year grace period prior to the effective filing date of this application.

### BACKGROUND OF THE INVENTION

### (1) Field of the Invention

(1) Field of the Invention: The present invention relates generally to the field of artificial intelligence (AI), quantum computing, and secure distributed systems. More specifically, it pertains to a modular AI-Quantum middleware and operating system that enables scalable hybrid workload orchestration, post-quantum secure communication, and autonomous decision optimization across classical and quantum-simulated computing architectures.
(2) Description of Related Art including information disclosed under 37 CFR 1.97 and 1.98:

### (2) Description of Related Art

Despite ongoing advances in both AI and quantum computing, existing systems lack the ability to unify these technologies into a scalable, real-time, and secure architecture for mission-critical applications. Conventional AI systems typically rely on classical processing resources—such as CPUs, GPUs, and TPUs—which are well suited for pattern recognition and deterministic inference but often fall short when addressing stochastic optimization, high-dimensional tensor problems, and dynamic multi-agent environments.

Quantum computing, on the other hand, holds promise for solving such problems through superposition, entanglement, and quantum interference. However, its practical use remains limited due to unstable hardware, short coherence times, and restricted access to quantum processing units (QPUs). The lack of mature quantum infrastructure constrains integration with AI systems at scale.

Existing hybrid solutions—often involving simulated quantum circuits on classical hardware or proprietary, GPU-accelerated frameworks—exhibit critical limitations:
Lack of modularity, preventing flexible deployment across embedded, edge, and cloud environments;
Minimal interoperability between classical and quantum systems;
Poor scalability under real-time constraints and dense tensor workloads;
Absence of post-quantum security measures, exposing systems to future cryptographic vulnerabilities.

Furthermore, these systems rarely support real-time compliance verification, swarm autonomy, or explainability-requirements essential for aerospace, defense, cybersecurity, and regulated enterprise sectors.

Accordingly, there exists a need for a unified platform that emulates quantum-scale inference on classical infrastructure while embedding post-quantum cryptographic protections and enabling distributed autonomy, orchestration, and certification. The present invention fulfills this need by introducing a novel software-defined AI-Quantum middleware and operating system capable of orchestrating hybrid workloads in real-time, even in the absence of physical quantum hardware.

### BRIEF SUMMARY OF THE INVENTION

The present invention provides a novel, software-defined AI-Quantum middleware and operating system that enables real-time orchestration of hybrid workloads across classical processors (CPUs, GPUs, FPGAs) and quantum or quantum-simulated computational environments. This invention bridges the divide between artificial intelligence and quantum computing by providing a modular, hardware-optional platform that supports high-order tensor emulation of quantum behavior, post-quantum secure communication, and distributed decision optimization.

Unlike conventional systems that require dedicated quantum hardware, the disclosed invention uses proprietary tensor factorization, algebraic decomposition, and context-aware workload balancing to emulate quantum-scale inference—equivalent to 60 to 100+ qubits—on classical infrastructure. It enables intelligent agents to operate in environments where quantum processors are either unavailable or infeasible, while retaining the benefits of quantum-inspired computation.

The system comprises four key components:

AI-Quantum Middleware Layer (quaiX Nexus)—A universal API gateway enabling framework-agnostic orchestration across AI and quantum platforms, including TensorFlow Quantum, Qiskit, and Cirq.

Hybrid Accelerator Engine (quaiXcore)—A dynamic inference routing system capable of latency-aware optimization and tensor-core acceleration in edge-native and mission-critical environments.

Post-Quantum Cryptographic Security Layer (quaiXsentinel)—A security framework incorporating lattice-based encryption, continuous-variable quantum key distribution (CV-QKD), and zero-trust authentication.

Swarm Intelligence and Digital Twin Module (quaiXtensor)—A tensor-driven multi-agent coordination system enabling distributed autonomy, swarm decision synchronization, and real-time regulatory compliance through explainable AI (XQAI) and mirrored simulations.

This invention offers a transformative solution for AI-enabled platforms that must operate in secure, high-assurance, and real-time environments such as unmanned aerial systems, satellite networks, battlefield edge nodes, critical infrastructure, and regulated enterprise domains. By integrating quantum-scale AI reasoning, post-quantum security, and dynamic workload orchestration into a single deployable framework, the invention redefines what is possible for next-generation intelligent autonomy.

### BRIEF DESCRIPTION OF THE SEVERAL VIEWS OF THE DRAWING(S)

FIG. 1 The accompanying drawings, which are incorporated into and form a part of this specification, illustrate various embodiments and features of the invention: FIG. 1—System Architecture Diagram: Illustrates the overall AI-Quantum middleware framework, showing key components including the orchestration engine, tensor factorization module, AI-Quantum acceleration layer, post-quantum security layer, and universal API gateway, along with data pathways across cloud, edge, and on-premise systems. FIG. 2—AI-Quantum Workload Balancing Flowchart: Depicts the dynamic routing logic of tasks between classical and quantum-simulated nodes, including resource evaluation, execution mode selection, and secure output finalization. FIG. 3—Post-Quantum Encryption Model: Shows the integrated cybersecurity framework with CV-QKD key generation, lattice-based encryption, zero-trust authentication, and distributed trust ledgers for secure AI-Quantum communication. FIG. 4—Autonomous Swarm Coordination Workflow: Demonstrates the decision synchronization and real-time coordination of UAV swarms using quantum tensor networks (QTN), predictive flight pathing, threat detection, and airspace deconfliction. FIG. 5—Digital Twin Interface: Details the layered interface for mirroring autonomous systems in real time, including sensor data feeds, anomaly detection, compliance validation, operator UI, and predictive analytics. FIG. 6—SaaS Deployment and Fleet Certification Dashboard: Illustrates the cloud-native deployment framework and associated modules for AI model provisioning, compliance dashboards, telemetry auditing, trust token issuance, and real-time certification monitoring.

### DETAILED DESCRIPTION OF THE INVENTION

The present invention provides a modular, scalable, and hardware-optional AI-Quantum middleware and operating system that enables real-time hybrid workload orchestration across classical and quantum or quantum-simulated computational environments. The system supports autonomous operation, secure communication, explainable decision-making, and regulatory compliance, particularly in mission-critical domains such as aerospace, defense, cybersecurity, and intelligent infrastructure.

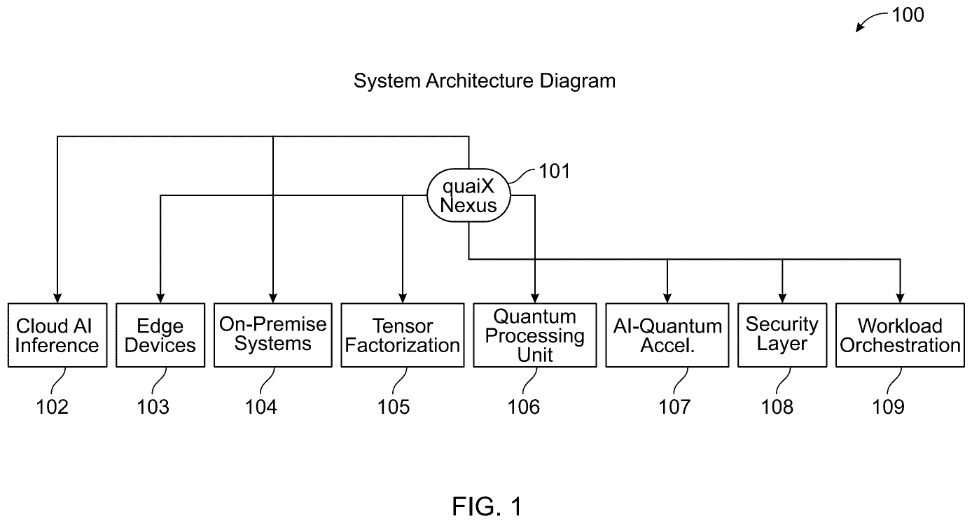

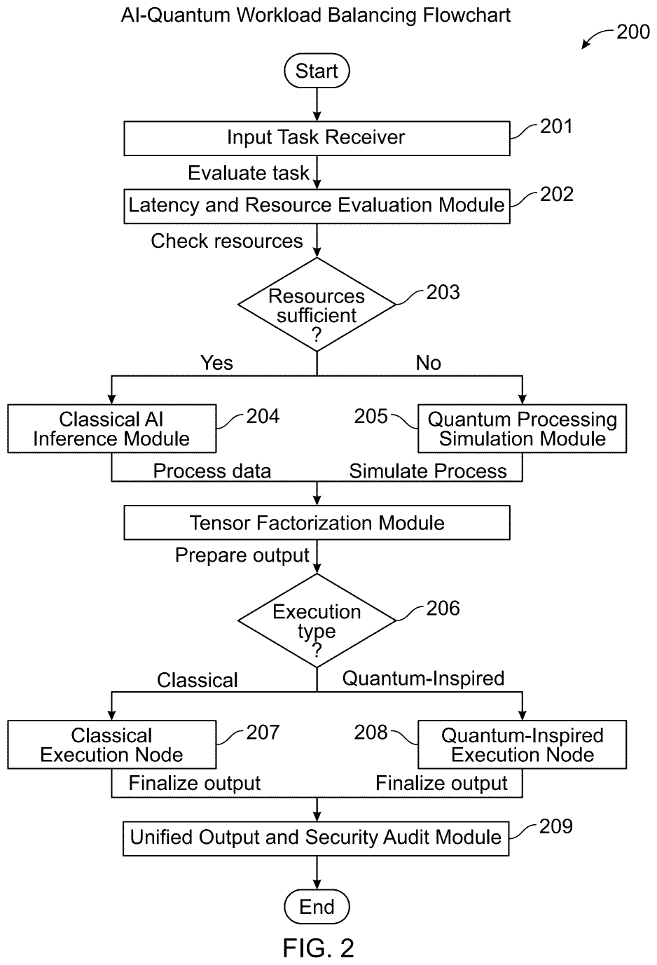

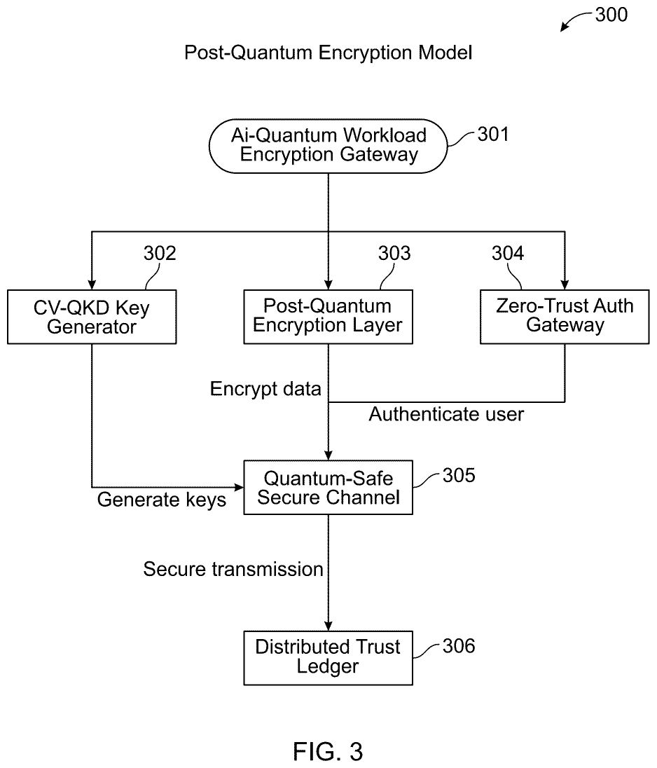

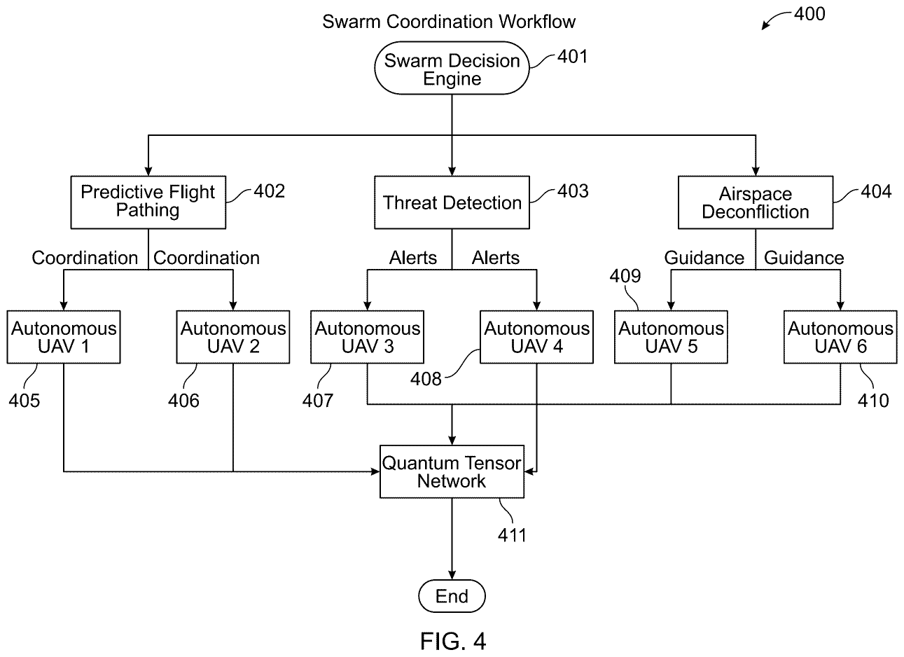

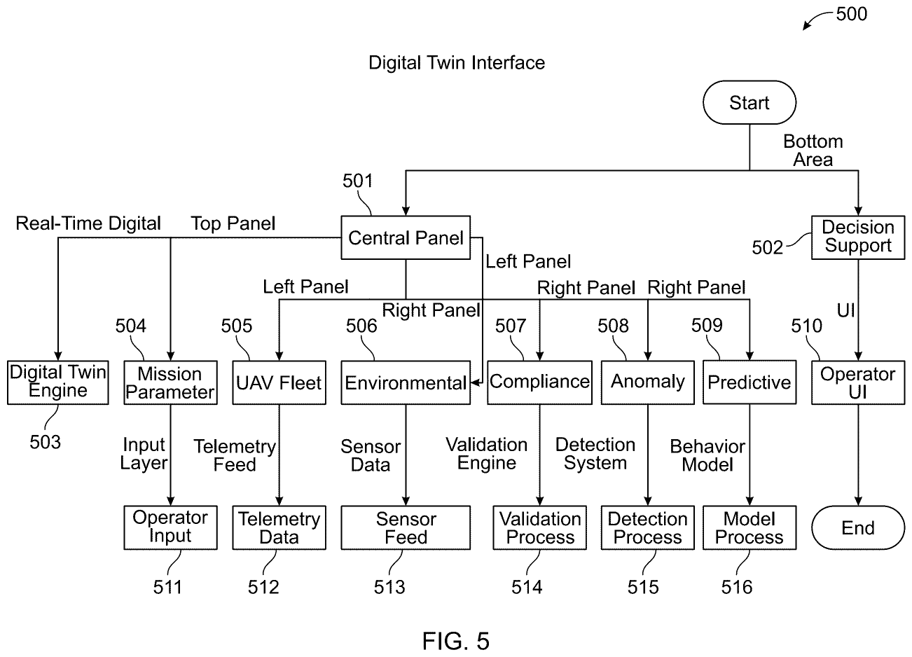

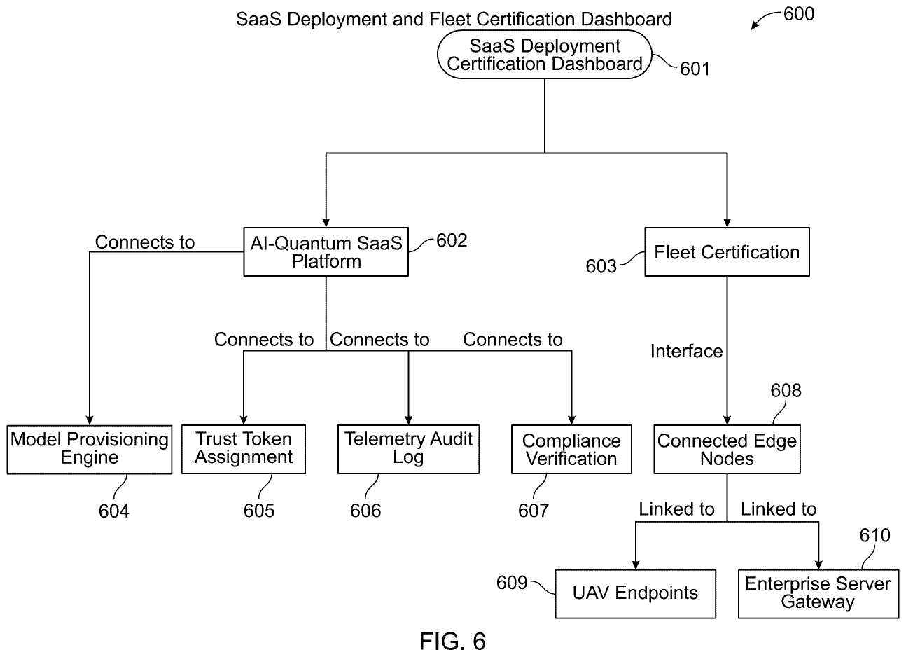

### System Overview (FIG. 1)

The system architecture includes a central AI-Quantum middleware layer, referred to as quaiX Nexus, interfacing with classical compute environments (e.g., CPUs, GPUs, FPGAs) and quantum-inspired processing cores. Tensor factorization modules emulate high-dimensional quantum states on classical infrastructure. A post-quantum security layer protects all system-level communications. The architecture is designed for flexible deployment across edge, on-premise, and cloud configurations.

### Hybrid Workload Orchestration (FIG. 2)

Tasks enter through an input receiver and are processed via a latency and resource evaluation module. Depending on resource availability and mission requirements, the system dynamically routes workloads to either classical AI inference modules or quantum-inspired processing modules. The tensor factorization engine emulates quantum-scale inference by applying high-order algebraic compression techniques, such as polytope transformations and unitary matrix approximation, enabling workloads up to 100+ qubit equivalence.

### Post-Quantum Security Framework (FIG. 3)

A robust cybersecurity layer, termed quaiXsentinel, is integrated throughout the architecture. It includes:
CV-QKD Key Generator for quantum-resilient key exchange;
Post-Quantum Encryption Layer employing lattice-based cryptographic schemes such as Kyber, Dilithium, and NTRU;
Zero-Trust Authentication Gateway that continuously verifies user, agent, and model integrity;
Distributed Trust Ledger for immutable audit trails and compliance verification.

These modules enable encrypted AI-Quantum collaboration across disconnected nodes, satellites, and air-gapped systems.

### Swarm Coordination and Multi-Agent Optimization (FIG. 4)

The invention enables coordinated swarm behavior using a Quantum Tensor Network (QTN) model. Each autonomous agent executes localized tensor operations while synchronizing decision states across the network. Predictive flight pathing, adversarial detection, and decentralized airspace deconfliction are handled in real time. The system supports autonomous UAV fleets, robotic swarms, and other sensor-driven platforms operating in GPS-denied or adversarial conditions.

### Digital Twin Validation Layer (FIG. 5)

A digital twin simulation engine provides mirrored environments for predictive mission analysis, compliance verification, and live anomaly detection. Real-time telemetry from the operational system is fed into the digital twin, enabling early detection of behavioral divergence, safety violations, or performance degradation. This engine supports predictive analytics and XQAI (Explainable Quantum AI) reporting.

### SaaS Deployment and Certification Infrastructure (FIG. 6)

The middleware supports Software-as-a-Service (SaaS) deployment models with cryptographic provisioning, remote configuration, and real-time certification dashboards. These interfaces allow regulators, operators, and auditors to verify system integrity, swarm behaviors, and compliance with national or international safety standards. Trust tokens are issued via secure gateways, ensuring authenticated, traceable, and revocable operational authority.

### Modularity and Deployment Scenarios

The entire platform is modular and adaptable to:
Embedded environments with limited computational resources;
Cloud-based AI platforms requiring scalable inference;
Edge-native deployments in battlefield or disconnected mesh networks;
Compliance-driven sectors such as aerospace, finance, and critical infrastructure.

It operates with or without quantum hardware, providing quantum-inspired functionality through tensor emulation methods. This design ensures operability even in environments lacking access to physical QPUs, enabling near-term deployment with long-term scalability.

### Novelty and Technical Advantages

Key innovations of the invention include:
Hardware-optional quantum-scale inference using tensor compression;
Integrated post-quantum security at the orchestration and transport layers;
Decentralized tensor swarm intelligence for real-time autonomous control;
Explainability and digital twin support for transparent compliance;
SaaS-ready interfaces for fleet-wide monitoring and certification.

Collectively, these capabilities enable a secure, scalable, and real-time framework for AI-Quantum systems, unlocking autonomous operations in complex, adversarial, or regulated environments.

1. A system for real-time autonomous UAV swarm orchestration, comprising:
a. an orchestration engine configured to receive mission telemetry from multiple UAV nodes of a UAV swarm, generate a multi-dimensional tensor representation (a swarm-state tensor) of a swarm state of the UAV swarm, and dynamically dispatch workload subfunctions across a distributed set of quantum processing units (QPUs) and classical compute units including CPUs, GPUs, and FPGAs based on mission context and resource availability;
b. a tensor factorization module operatively coupled to the orchestration engine, the tensor factorization module configured to emulate quantum-scale inference by applying high-order algebraic compression techniques, including at least one of polytope transformations and unitary matrix approximation, to compress the swarm-state tensor;
c. a universal application programming interface (API) gateway in operative communication with the orchestration engine and the UAV nodes, the API gateway configured to bridge heterogeneous computing protocols and enable task invocation across classical and quantum resources;
d. a post-quantum cryptographic security framework comprising lattice-based encryption and continuous-variable quantum key distribution (CV-QKD), wherein the post-quantum cryptographic security framework authenticates inter-UAV communications and secures an orchestration command channel for transmitting orchestration commands between the orchestration engine and the UAV nodes; and
e. a fallback control logic configured to monitor quantum execution latency or fault conditions and reroute affected workload subfunctions from the QPUs to the classical compute units to ensure deterministic mission continuity.

2. A modular middleware platform for real-time digital twin orchestration and compliance validation comprising:
(a) a telemetry ingestion layer configured to receive real-time data streams from autonomous platforms;
(b) a tensor-based digital twin engine configured to simulate mission states and predictive deviations;
(c) a swarm coordination module implementing quantum tensor network (QTN) modeling for distributed synchronization of autonomous agents; and
(d) a compliance verification layer configured to generate explainable audit trails based on mirrored agent behaviors and regulatory parameters.

3. A secure, software-defined execution environment for AI-Quantum systems, comprising:
(a) a runtime engine for context-aware allocation of hybrid workloads across edge, embedded, or cloud-based compute nodes;
(b) an AI inference module incorporating probabilistic reasoning and multi-agent reinforcement learning;
(c) a quantum emulation module operable to execute algebraically compressed quantum logic on tensor-enabled classical substrates; and
(d) a zero-trust authentication mechanism configured to validate agent identity, integrity of inference models, and encrypted mission telemetry in real time.

4. The system of claim 1, wherein the orchestration engine, the tensor factorization module, and API gateway are jointly deployed on at least one edge computing platform onboard at least one of the UAV nodes.

5. The system of claim 1, wherein the tensor factorization module applies unitary matrix approximation to generate an algebraically compressed tensor representation executable on the classical compute units under degraded quantum availability.

6. The system of claim 1, further comprising a distributed ledger engine configured to record time-stamped orchestration decisions and inter-UAV consensus votes in a tamper-evident blockchain, wherein
the distributed ledger engine synchronizes the tamper-evident blockchain among the UAV nodes without centralized authority.

7. The platform of claim 2, wherein the digital twin engine receives mirrored telemetry from swarming unmanned aerial vehicles (UAVs) in real time.

8. The platform of claim 2, wherein the compliance verification layer implements explainable quantum artificial intelligence (XQAI) to provide logic traceability of decisions.

9. The environment of claim 3, wherein the quantum emulation module achieves inference performance equivalent to 60-100 qubits using tensor slicing and algebraic routing.

10. The environment of claim 3, wherein the zero-trust authentication mechanism is integrated with cryptographic key lifecycle management for dynamic session control.

11. (canceled)

12. (canceled)
